(19) United States
(12) Patent Application Publication
(10) Pub. No.: US 2020/0385195 A1
(43) Pub. Date: Dec. 10, 2020

(54) System, Method, and Apparatus for an Insulating Packaging Product

(71) Applicant: Kevin Lee Lyons, Louisville, KY (US)

(72) Inventor: Kevin Lee Lyons, Louisville, KY (US)

(21) Appl. No.: 17/001,605

(22) Filed: Aug. 24, 2020

Related U.S. Application Data
(63) Continuation-in-part of application No. 16/548,634, filed on Aug. 22, 2019.
(60) Provisional application No. 62/721,009, filed on Aug. 22, 2018.

(51) Int. Cl. B65D 81/38; B65D 5/34; B65D 5/18; B65D 65/40; B32B 5/02; B32B 5/26

(52) U.S. Cl. CPC B65D 81/3848; B65D 5/325; B65D 5/18; B32B 2439/62; B32B 5/02; B32B 5/26; B32B 2262/0284; B65D 65/40

(57) ABSTRACT

The present invention pertains to the art of packing materials. The present invention provides a thermally-insulating and compostable packing product made of a compostable thin-film material forming an enclosed envelope filled with compressed corn-starch. The packing product of the present invention may be folded and positioned within a container to physically and thermally insulate or isolate an item for shipping within the container.

### CROSS-REFERENCE AND CLAIM OF PRIORITY

The present invention claims the benefit of priority to U.S. Prov. Pat. App. 62/721,009, filed Aug. 22, 2018, entitled SYSTEM, METHOD, AND APPARATUS FOR AN INSULATING PACKAGING PRODUCT, Lyons, which is incorporated by reference herein in its entirety. The invention also claims the benefit of priority to U.S. Utility patent application Ser. No. 16/548,634, filed Aug. 22, 2019 and entitled SYSTEM, METHOD, AND APPARATUS FOR AN INSULATING PACKAGING PRODUCT, which is also incorporated by reference herein in its entirety.

### FIELD OF THE INVENTION

The present invention pertains to the art of packaging. Specifically, the present invention relates to a foldable packing material with insulating, compostable contents disposed within a thin film envelope.

### BACKGROUND

In the field of packaging, there are many solutions for protecting and positioning items during shipping. Traditional solutions may include using corrugated cardboard boxes filled with loose polystyrene packing filler or wadded paper packing material. For more sensitive items, form fitting polystyrene or expanded polystyrene (EPS) packaging may be used that is molded to the shape of the item being shipped. Other packing materials may include air bags positioned around an item in a shipping container.

There are limitations to these traditional packing materials. Loose filled packing materials such as “packing peanuts” or wadded paper may allow for an item to shift or move within a shipping container. EPS molded packing material or other form fitting packing material, such as shaped and folded corrugated cardboard, address the issue of an item shifting within a container, but have their own drawbacks.

For example, corrugated cardboard may be folded into a shape to relatively closely conform to the shape of an item being shipped. However, it may be difficult to design an efficient and sufficiently strong folding structure for the cardboard, i.e., one that may be produced and folded quickly and inexpensively. Additionally, folded cardboard packing material does not provide sufficient insulating properties and has an insufficient R value for shipping items that must be kept at or below a certain temperature in transit.

Molded EPS packing material addresses some of these issues. Molded EPS packing material may have better insulating properties than cardboard but is non-recyclable and is environmentally hazardous. EPS is also bulky and difficult to ship from a production facility to a packing facility where it is to be used.

Other solutions also exist for producing packing material that addresses the issues of loose filled packing material and the form fitting packing material discussed above. A system and method for producing a thin-film bag filled with polystyrene pellets is disclosed in U.S. Pat. No. 8,011,511, entitled PACKING MATERIAL AND METHOD, by Oyler et al., issued Sep. 6, 2011, and in U.S. Pat. No. 6,085,909, entitled REUSABLE FLEXIBLE BAG FOR PACKAGING OBJECTS, by Lyons, issued Jul. 11, 2000, both of which are incorporated herein by reference in their entirety. A commercial product, the SIMPAD product packaging technology by SIMPAK INTERNATIONAL, uses the thin-film envelope and pellet fill described in the '511 and '909 patent applications.

However, with the existing systems and methods for using thin-film bags filled with a packing material, little consideration is given to the environmental impact of the packing material once it has been used. Some companies have attempted to address these issues by using different packing fill. For example, the KWIKPACK™ with KODIAKOTTON® by KODIAKOOLER®, uses a filler material comprised of cotton and other natural fibers in a thin-film plastic envelope. A drawback of the solution provided by KODIAKOOLER is that the product itself is bulky, does not provide sufficient protection, insulation, and cushioning to items being shipped, and is not completely bio-degradable.

Packaging solutions such as EPS formed coolers and cardboard containers with an insulating liner, e.g., EPS molded packing material or KWIKPACK type packing material, are commonly used to ship medical products and food products. Common applications for “cold-chain” shipping are the packaging and shipping of medicines and medical samples by pharmaceutical and medical products companies, and the shipping of food items by home-delivery food services such as HELLO FRESH and BLUE APRON. These insulation and shipping solutions are used in conjunction with a cold pack, such as a PACTEMP cold chain packing product like the PACTEMP CREATIVE ICE product by the CREATIVE PACKAGING COMPANY. The packaging solution must keep the products or items being shipped at the proper desired temperature, typically at or below 8° C., and must also provide sufficient protection and cushioning to the items being shipped. Additionally, recently the costs of shipping and logistics for shipping packaging materials has increased nearly 20-30%, so it is desirable to have a packaging solution that may be easily produced at or near the packaging location. It is also desirable for the packaging solution to be environmentally friendly in both production and disposal.

A packing solution may have varying levels of environmental friendliness. The environmental friendliness of an item its impact, positive or negative, on a particular ecosystem or environment. A positive environmental friendliness is desired, but the typical target is to have the least negative impact possible. The levels, from lowest environmental friendliness to highest, are non-recyclable, renewable, reusable/recyclable, recyclable, biodegradable, compostable, and water-soluble. Non-recyclable items are items that can only be disposed of in a landfill and cannot be recycled. Renewable items are those that are made from materials that may be renewed or replaced, e.g., wood pulp from trees. Reusable and recyclable items are those that may be reused or broken down into component parts and re-made into another useable item, e.g., shredding plastic bottles to be re-made into new plastic bottles.

Biodegradable items are those that may be broken down into their smallest possible components by micro and macro-organisms without causing harm to those organisms. Biodegradable items may take months or years to fully biodegrade, and therefore may not be particularly environmentally friendly. For an item to be both biodegradable and environmentally friendly, it must biodegrade in a relatively short period of time, e.g., months. The highest level of environmental friendliness of an item is one that is compostable.

A compostable item is similar to a biodegradable item except that it can be broken down exceptionally quickly, typically in a few weeks. Compostable items break down into CO2, biomass, and inorganic compounds that may be used as a compost in soil. Compostable items also leave behind no residue of the item after it has fully biodegraded. A compostable packaging solution is the ultimate goal for obtaining the best environmental friendliness. All compostable items are biodegradable because compostable items are broken down into the smallest possible components, but not all biodegradable items are compostable because not all biodegradable items degrade into organic materials that offer nutrients to the surrounding environment. Water soluble is the most desirable level of environmental friendliness, especially where the product, once dissolved in water, does not harm the ecosystem, water table, or water source in any way.

Furthermore, it is desirable to have a packaging solution that may be produced by a machine having a small physical “footprint” and having a low carbon output and high electrical efficiency.

What is needed is a system and method for producing a compostable packaging product that provides sufficient insulation and protection for items being shipped. The protective, insulating packaging product must also be compostable after use. The packaging product should also have a sufficient shelf-life to be usable commercially in large and logistically complex supply-chains.

### SUMMARY OF INVENTION

The present invention provides a system, apparatus, and method for an insulating and compostable packaging product. The insulating and compostable packaging product of the present invention comprises a film envelope filled with packaging insulation, which in one embodiment are a plurality of insulation pellets. The thin-film envelope of the present invention is comprised of a compostable material with similar characteristics to an oil-based polymer material. In one embodiment, the packaging insulation of the present invention is compressed corn-starch material that is fully dissolvable in a solvent such as water. Alternatively, the filler material may be another suitable water-soluble pelletized material such as a potato starch material.

The materials, compounds, and processes used provide an insulating and compostable packaging product that may be used in a cold supply chain to insulate and protect items during shipping. After the insulating and compostable packaging product has been used to ship an item, it may be disposed of by placement in a compost heap or pile of sufficient moisture and temperature for the eventual disintegration of the thin-film envelope and corn-starch filler material.

In some embodiments, the compostable thin-film liner may be replaced with a biodegradable thin-film that is not classified as compostable if a longer shelf-life or more durable characteristics are needed from the thin-film for a specified shipping scenario. One thin-film that may be used in this instance is the NATUREFLEX™ thin-film by FUTAMURA GROUP. The NATUREFLEX thin-film is one commercial embodiment of a compostable and biodegradable thin-film with characteristics similar to those of traditional oil-based polymer thin-films used in packaging material. Additionally, in some aspects and embodiments the thin-film material may be comprised of a biodegradable thin-films such as corn-starch or a similar equivalent.

The present invention provides an inclusive insulating and compostable packaging product that can maintain a temperature of 2-8° C. within a shipping container such as a corrugated cardboard container. The design of the insulating and compostable packaging product of the present invention is generally a cross- or x-shape constructed of either two layers of thin-film sealed about the edges to form an envelope for containing the corn-starch insulation material, or of a single-sheet sealed at each open end.

The interior of the insulating and compostable packaging product may be vacuum-sealed, sealed with a partial vacuum, or sealed without a vacuum, but sealed through removing or purging the air inside the product. The air comprising the internal volume of the product may be purged and replaced with a more inert gas, such as nitrogen, to discourage premature biodegradation. The use of corn starch or other compostable or biodegradable material packaging product, versus expanded polystyrene may provide improved thermal and physical protection characteristics.

The body of the packaging product may be formed from a single sheet of a thin-film material forming an enclosed envelope in which a filler material is disposed. The filler material forms an isolating layer which thermally and physically insulates an item or product within a shipping container, the item or product disposed within an enclosure formed by folding the body of the packaging product within the shipping container.

In some aspects and embodiments the body of the packaging product may be formed from a single sheet of polyethylene terephthalate fiber material (commonly known as PET fiber) having a predetermined thickness according to the desired insulation properties of the packaging product. In certain embodiments the single sheet of material is folded to produce a liner for a packing box. The liner may be folded to fit closely inside a packing box, thereby insulating the contents thereof.

In certain aspects and embodiments the body of the packaging product may be formed from two pieces of PET fiber material that are then assembled into a packaging liner. In these embodiments each of the two pieces are generally rectangular in shape and may then be folded to produce a “clamshell” liner construction.

In accordance with some embodiments the PET fiber material may be singed or heated along all exterior surfaces thereof to produce a packaging product having exterior surfaces that are sealed and thus are relatively impervious to fluids as well as having additional insulating value for a packaging product. The packaging product of these embodiments may be produced by heating a shaped PET fiber liner, whether in one piece or multi-piece construction, under pressure in a press or equivalent apparatus.

The present invention provides significant improvements over environmentally damaging petroleum-based packaging products and over multi-piece packaging products. The packing product of the claimed invention is biodegradable and in some embodiments is compostable or water-soluble. The packing product of the present invention addresses needs expressed by pharmaceutical and home meal kit delivery services. Customers in the home meal kit and pharmaceutical spaces have expressed a need for a more environmentally sustainable cold-chain solution as these services wish to move from the use of EPS coolers. The packing product of the claimed invention provides an environmentally friendly and sustainable solution in applications where temperature control is critical and sustainability is a priority. Performance is critical in home meal kit delivery services and for pharmaceutical companies where significant liability may result from product spoilage.

The packing product of the present invention may be manufactured in one or two pieces and in a variety of sizes for placement in shipping containers such as corrugated cardboard boxes typically used for residential and commercial shipping applications. The packing product of the present invention comprises a one-piece design that provides significant operational advantages including: inventory reduction; increased productivity resulting from a streamlined assembly process; and reduced assembly errors and product failures due to comprising fewer pieces than prior art packing products. For example, a packing product of the present invention may provide cost savings of 10-20% compared to existing packing liners.

The performance of the packing product of the claimed invention has been chamber validated in summer heat conditions and maintains an internal enclosure temperature of at or below 4 degrees Celsius for more than 72 hours in a simulation of a home meal kit delivery package, and maintains an internal enclosure temperature of at or below 8 degrees Celsius for more than 48 hours ins a simulation of refrigerated pharmaceutical shipments (respectively shown in chart 1000 in FIG. 10 and in chart 1100 in FIG. 11).

The packing product of the present invention may be manufactured by a single forming, filling, and sealing machine or may be manufactured by a plurality of machines working in tandem.

In a first embodiment, the present invention provides an insulating and compostable packing product comprised of two elements. The first element is a body formed by a compostable thin-film material and including a middle section, a first arm, a second arm, a third arm, and a fourth arm. The body includes an interior space, sides, and a thickness, with each of the first, second, third, and fourth arms disposed cardinally about and extending outwards in a common plane from the middle section, with the first and second arms being relatively longer than the third and fourth arms. The second element is a compostable, insulating corn-starch material disposed within the thin-film body of the packing product. The packing product is adapted to be folded within a container to form an enclosed space within the container for thermally insulating and physically isolating an item within the container.

The body may be formed by a top layer and a bottom layer joined at a seam about the sides of the body. The body may also be formed by a single sheet of thin-film material sealed at the ends of each of the first, second, third, and fourth arms. The compostable insulating material may be comprised of a corn-starch material. The thickness of the body may be 2 inches. A portion of each of the first arm and second arms may be adapted to form the top of an enclosed space within the container when the body of the product is folded within the container.

In another embodiment, the present invention provides an insulating, compo stable packing product comprising: a body comprising a thin-film material and having a middle section, a first arm, a second arm, a third arm, and a fourth arm, the body further comprising an interior space, sides, and a thickness; wherein each of the first, second, third, and fourth arms are disposed cardinally about and extending outwards in a common plane from the middle section; a pelletized filler material disposed within the body of the packing product; and wherein the packing product is adapted to be folded within a container to form an enclosed space within the container for thermally insulating and physically isolating an item within the enclosed space in the container.

The packaging product of the above embodiment may further comprise wherein the thin-film material comprises a compostable thin-film material. The thin-film material may comprise a water-soluble thin-film material. The pelletized filler material may comprise a water-soluble material. The pelletized filler material may comprise a plurality of compostable, insulating corn-starch based pellets. The first arm may be relatively longer than the second, third, and fourth arms. The first arm and the second arm may be relatively longer than the third arm and the fourth arm. The body may comprise a top layer and a bottom layer joined at a seam about the sides of the body. The body may comprise a single sheet of thin-film material sealed at the ends of each of the first, second, third, and fourth arms. The thickness of the body may be 2 inches. The thickness of the body may be 1.25 inches. The packaging product may further comprise wherein a portion of the first arm is adapted to form a top of the enclosed space within the container when the body of the product is folded within the container. The packaging product may maintain a temperature below 4 degrees Celsius within the enclosed space for a period of 72 hours when exposed to an external temperature exceeding 25 degrees Celsius. The packaging product may maintain a temperature below 8 degrees Celsius within the enclosed space for a period of 48 hours when exposed to an external temperature exceeding 25 degrees Celsius.

In another embodiment, the present invention provides an insulating, compo stable packing product adapted to be folded within a container to form an enclosed space within the container for thermally insulating and physically isolating an item within the enclosed space in the container, the packing product comprising: a body comprising a compostable thin-film material, a middle section, a first arm, a second arm, a third arm, a fourth arm, an interior space, a set of sides, and a thickness; wherein the interior space formed by and is disposed within the compostable thin-film material and is sealed by a partial vacuum; wherein each of the first, second, third, and fourth arms are disposed cardinally about and extending outwards in a common plane from the middle section, and the first arm is relatively longer than the second, third, and fourth arms; and a water-soluble, pelletized filler material disposed within the body of the packing product, the water-soluble, pelletized filler material forming a thermally insulating and physically isolating layer and having a malleable, semi-rigid structure; wherein the packaging product maintains a temperature below 8 degrees Celsius within the enclosed space for a period of 48 hours when exposed to an external temperature exceeding 25 degrees Celsius.

The packaging product of the above embodiment may further comprise wherein the body comprises a top layer and a bottom layer joined at a seam about the sides of the body. The body may comprise a single sheet of thin-film material sealed at the ends of each of the first, second, third, and fourth arms. The thickness of the body may be between 1.25 and 2 inches, inclusive. The packaging product may further comprise wherein a portion of the first arm is adapted to form a top of the enclosed space within the container when the body of the product is folded within the container. The packaging product may maintain a temperature below 4 degrees Celsius within the enclosed space for a period of 72 hours when exposed to an external temperature exceeding 25 degrees Celsius.

In another embodiment the present invention provides an insulated shipping assembly for providing an enclosed space for thermally insulating contents from ambient temperature, the shipping assembly comprising: a container having four sides, a top and a bottom defining a first interior space; and a compostable and thermally-insulating packing product comprising: a body defined by a skin of thin-film material, the body having an unfolded configuration and a folded configuration, when unfolded the body being essentially cross-shaped and having an essentially square-shaped central portion with four arm portions extending outward from respective sides of the square-shaped central portion, each of the four arm portions adapted to be folded upward at a respective side of the square-shaped central portion; a pelletized filler material disposed within the body skin, the body skin being sealed to prevent release of the filler material; wherein the compostable and thermally-insulating packing product is adapted to be folded and positioned within the first interior space of the container so as to define a second interior space within the first interior space to receive for shipping a set of thermally-sensitive contents; and wherein the filler material has thermal insulative qualities for thermally insulating and isolating the set of thermally-sensitive contents when enclosed within the first and second interior spaces.

The insulated shipping assembly of the above embodiment may further comprise wherein at least one of the four arm portions includes a top portion adapted to fold over and enclose the second interior space within the first interior space. The four arm portions may be folded upwards relative to the central portion, with the body disposed within the first internal space and with the central portion disposed over the bottom of the container and the four arms adjacent respective ones of the container four sides. The insulated shipping assembly may further comprise wherein two of the four arm portions are relatively shorter than the other two arm portions and with the body disposed within the first interior space the distal ends of the shorter arms extend to the top of the container and, the relatively longer arm portions extending beyond the top of the container, whereby the length of the two relatively longer arms that extend beyond the top of the container are configured to be folded over inwards towards each other to form a top layer opposite the central portion and enclosing the second interior space within the container.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a top perspective view of an embodiment of a compostable and thermally-insulating packing material according to the present invention.

FIG. 2 is a top perspective view of an embodiment of a compostable and thermally-insulating packing material with thermal scoring marks at the middle section to provide for folding of the packing material according to the present invention.

FIG. 3 is a top perspective view of an embodiment of a compostable and thermally-insulating packing material having generally rounded edges with thermally sealed sides according to the present invention.

FIG. 4 is a left side view of an embodiment of a compostable and thermally-insulating packing material comprising a top layer and a bottom layer of thin film being thermally joined about the entire exterior of the side of the packing material according to the present invention.

FIG. 5 is a left side view of an embodiment of a compostable and thermally-insulating packing material comprising a thin film envelope being thermally sealed at the ends of each arm of the packing material according to the present invention.

FIG. 6 is a partial side cross-section view of an embodiment of a compostable and thermally-insulating packing material showing a filler material comprising a plurality of beads according to the present invention.

FIG. 7 is a top perspective view of a container with an embodiment of a compostable and thermally-insulating packing material positioned within the container according to the present invention.

FIG. 8 is a top perspective view an embodiment of a compostable and thermally-insulating packing material having three arms of equal length and having one arm of a longer length unequal to that of the other arms according to the present invention.

FIG. 9 is a top perspective view an embodiment of a compostable and thermally-insulating packing material having three arms of equal length and having one arm of a longer length unequal to that of the other arms according to the present invention.

FIGS. 10 and 11 are charts illustrating the thermally insulating performance of the thermally-insulating packing material according to an embodiment of the present invention.

FIG. 12 is a top view of an embodiment of a thermally insulating packaging product according to some embodiments.

FIG. 13 is a perspective view of a thermally insulating packaging product according to some embodiments.

### DETAILED DESCRIPTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

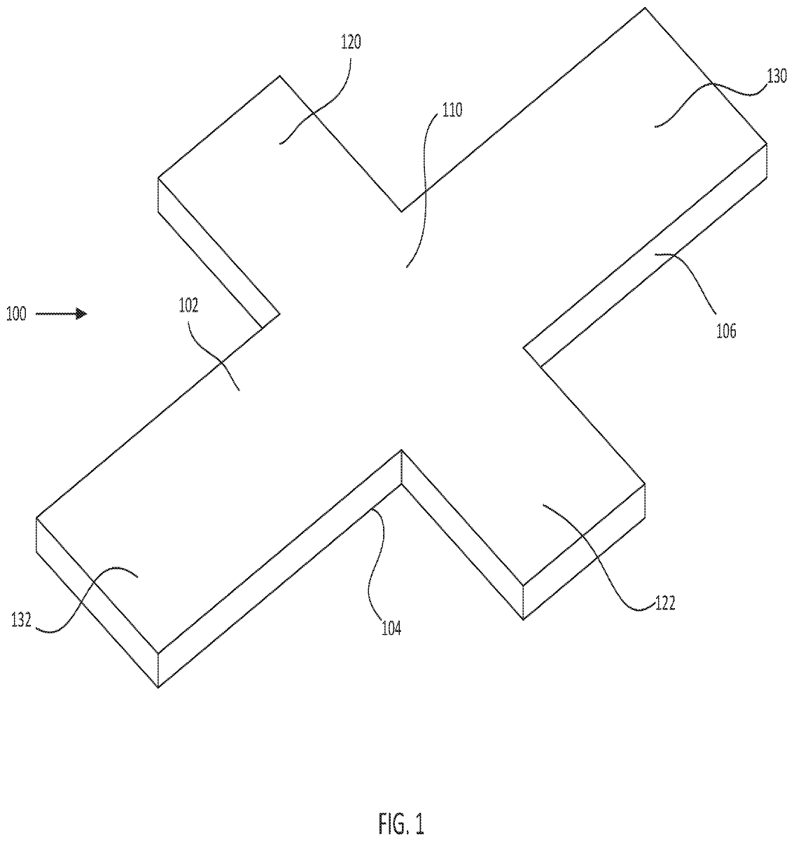

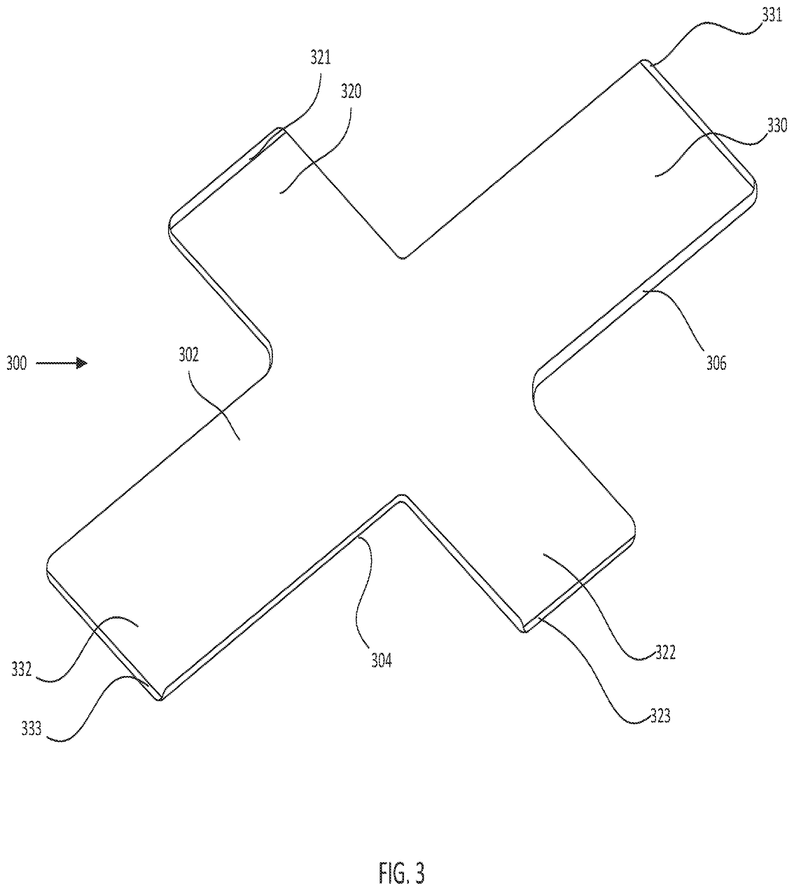

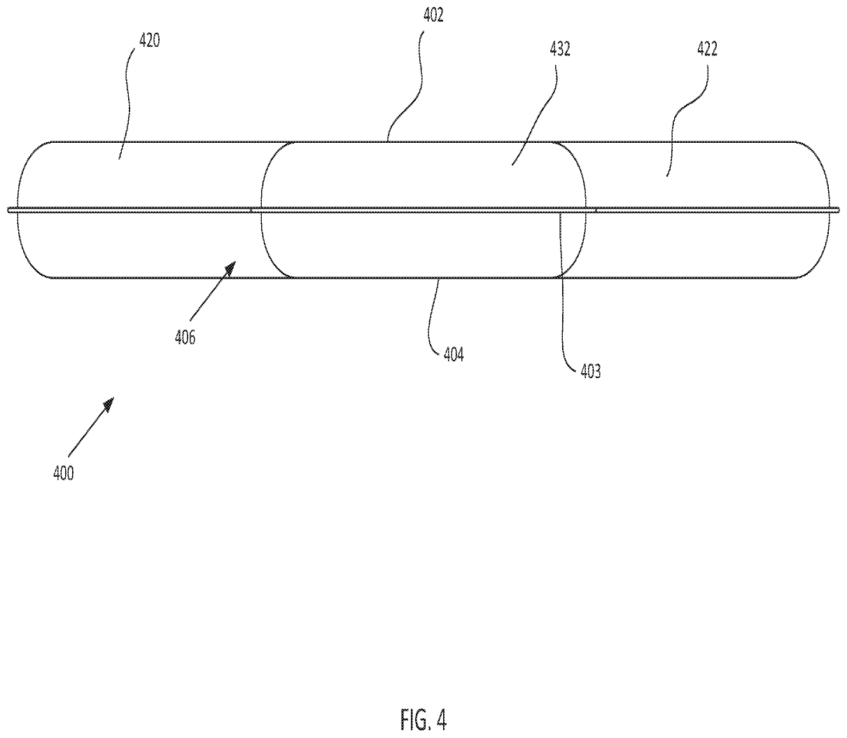

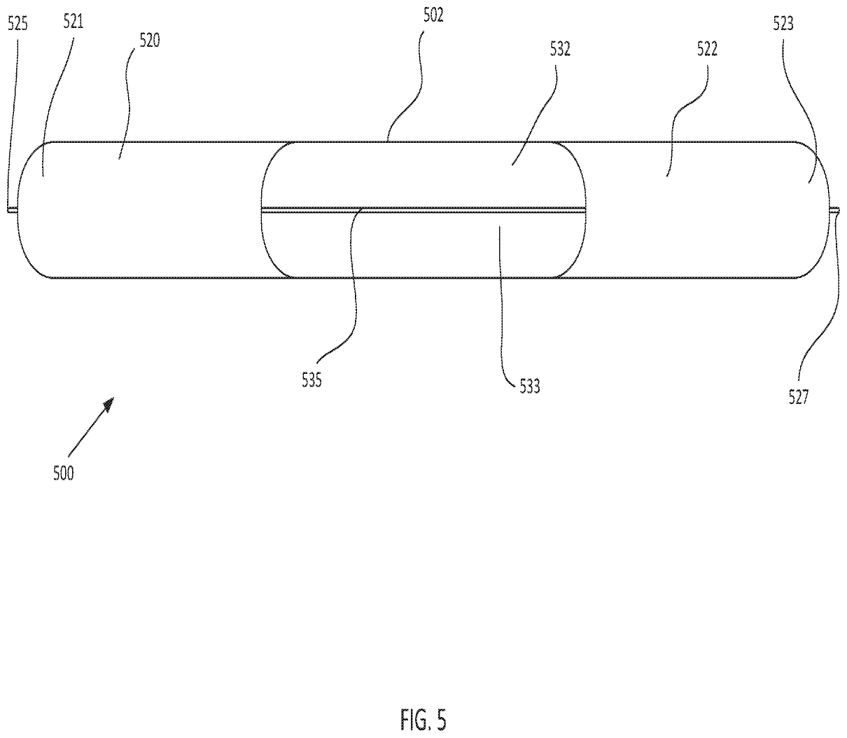

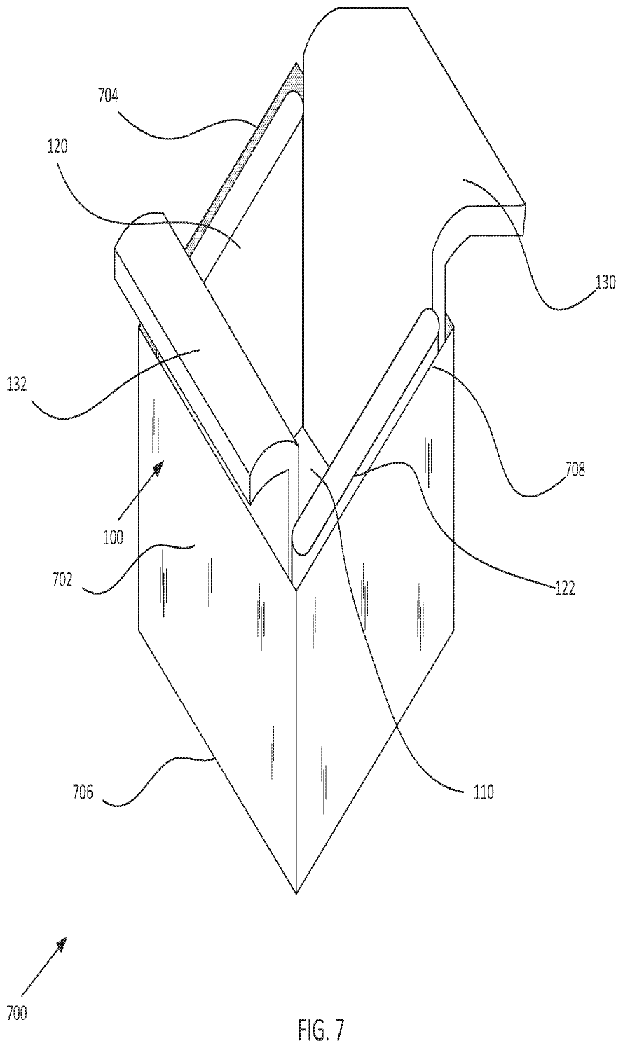

With reference first to FIG. 1, a top perspective view of an embodiment of a compostable and thermally-insulating packing product 100 is provided. The packing product 100 is generally cross- or x-shaped and has four arms 120, 122, 130, and 132 disposed on perpendicular axes and in the same plane as a middle section 110. A top thin-film layer 102 and bottom thin-film layer 104 may be joined to a side layer 106 forming an envelope within which a plurality of compressed compostable beads may be contained. The top 102 and bottom 104 thin film layers may also be joined directly together as shown in FIGS. 3 and 4 or may be a single layer joined at the ends of each arm 120, 122, 130, and 132 as shown in FIG. 5. The entire exterior of the product 100 is comprised of a compostable and/or biodegradable thin-film material. Two arms, arm 132 and arm 130, may be longer than the other two arms, arm 120 and arm 122, to provide for completely enclosing an item within a shipping container, as shown in FIG. 7. The thickness of the side 106 of the product 100 is approximately 2 inches. The length of arms or sides 130 and 132 is approximately 42 inches, and the length of the arms 120 and 122 is approximately 25 inches. However, the lengths of each arm may be changed to fit the shipping container in which the product 100 is to be used. A portion of each arm 130 and 132 forms the top of an enclosure when folded over within a container as shown in FIG. 7.

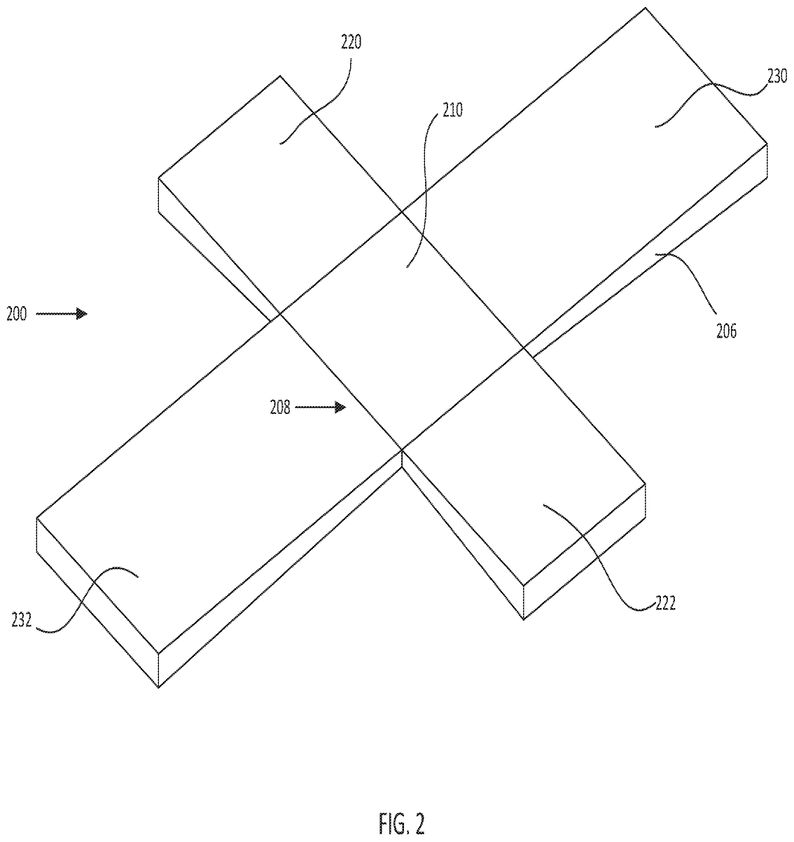

With reference now to FIG. 2, a top perspective view of an embodiment of a compostable and thermally-insulating packing product 200 with thermal scoring marks 208 at the middle section 210 to provide for folding of the packing product 200 is provided. The packing product 200 comprises four arms, arm 220, arm 222, arm 230, and arm 232, with arms 230 and 232 being relatively longer than arms 220 and 222. Where ach arm 220, 222, 230, and 232 joins the middle section 210, a thermal scoring mark 208 may be used to reduce the thickness of the product 200 to provide for easier folding of the product 200 within a shipping container. This may also form individual compartments for each of the middle section 210, and arms 220, 222, 230, and 232. The thickness of the side 206 may be reduced gradually from the end of each arm towards the middle section 210 or may suddenly decrease at the thermal scoring mark 208 while otherwise maintaining a relatively constant thickness.

With reference now to FIG. 3, a top perspective view of an embodiment of a compostable and thermally-insulating packing product 300 having generally rounded edges 306 with thermally sealed sides is provided. The packing product 300 is similar to the packing products 100 and 200 shown in FIGS. 1 and 2, but is comprised of top thin-film layer 302 and bottom thin-film layer 304 sealed about sides 306 and at arm ends 321, 323, 331, and 333 of respective arms 320, 322, 330, and 332. The sealing of the top 302 and bottom 304 layers about sides 306 and at arm ends 321, 323, 331, and 333 forms an envelope or enclosed space within the product 100 within which packing material, such as compressed corn-starch pellets or beads, may be contained. The top 302, bottom 304, and sides 306 may also be a single piece or sheet of thin-film material needing only to be sealed at the arm ends 321, 323, 331, and 333, reducing assembly complexity and costs. In another embodiment, the product 300 may only need to be sealed at any of one, two, or three arm ends instead of at all four, further reducing assembly complexity and cost.

With reference to FIG. 4, a left side view of an embodiment of a compostable and thermally-insulating packing product 400 comprising a top layer 402 and a bottom layer 404 of compostable thin-film being thermally joined about the entire exterior of the side 406 of the packing product 400 is provided. In the side view provided in FIG. 4, arms 420 and 422 can be seen extending outward from a middle section (not shown) and arm 432 is extending towards the viewer's perspective. The top layer 402 and bottom layer 404 are joined at seam 403 about the entire side 406 of the product 400 forming an enclosed envelope. The ends of each arm, e.g., arms 420, 422, and 432, may remain unsealed until the envelope is filled with a packing material after which the ends may be sealed. The sealing at the seam 403 may be done thermally or by a suitable adhesive.

With reference now to FIG. 5, a left side view of an embodiment of a compostable and thermally-insulating packing product 500 comprising a thin film envelope 502 being thermally sealed at the ends 525, 527, and 535 of each respective arm 520, 522, and 532 of the packing product 500 is provided. The packing product 500 shown in FIG. 5 comprises a single thin-film envelope 502 instead of, as shown in FIG. 4, a top and bottom layer sealed or joined together at a seam. The envelope 502 of the packing product 500 is, prior to sealing, open only at the ends 521, 523, and 533 of respective arms 520, 522, and 532. In other embodiments, one or more of the arm ends may be part of the single-sheet thin-film envelope 502 and may not require sealing. For example, only arm end 533 of arm 532 may be open while the other arm ends 521 and 523 of respective arms 520 and 522 may not require sealing and may be part of the envelope 502 that forms the body of the product 500.

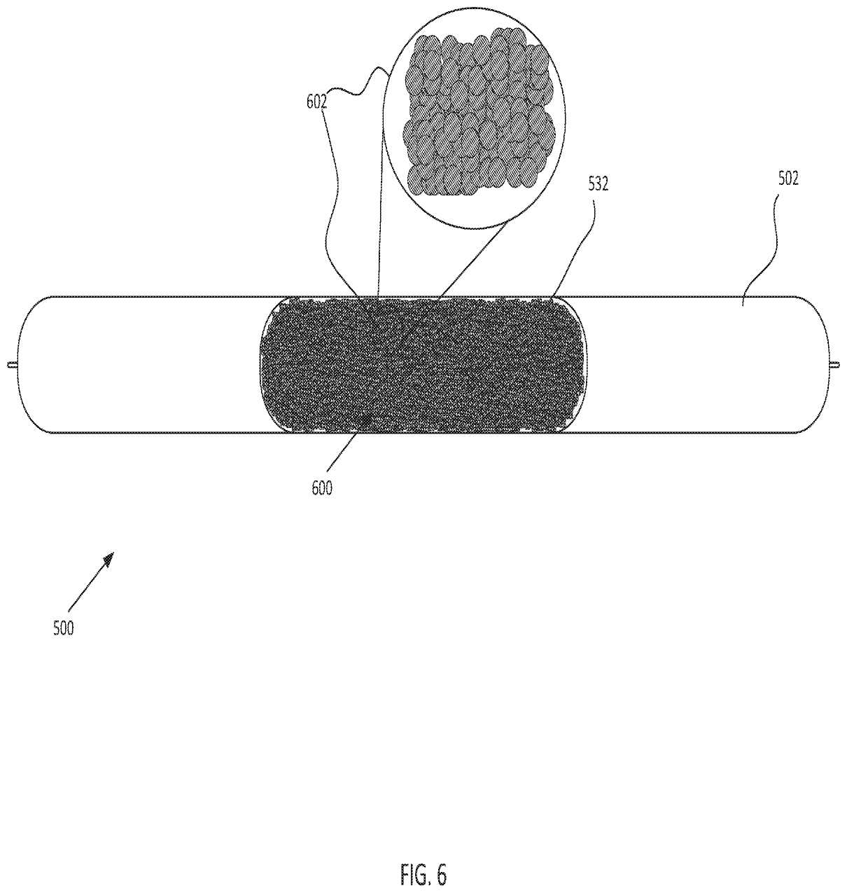

With reference now to FIG. 6, a partial side cross-section view of an embodiment of a compostable and thermally-insulating packing product 500, as shown in FIG. 5, showing a filler material 600 comprising a plurality of compressed corn-starch beads is provided. The partial cross-section of the arm 532 of the product 500 shows the interior of the envelope or body 502 of the product 500 at the arm 532. The interior of the product 500 is filled with a plurality of compressed corn-starch beads 600, shown in greater detail at 602. The beads 600 are loose filled within the envelope 502 of the product 500 before it is sealed. When the product 500 is sealed, air may be partially or completely removed from the product 500, or the air may be purged and replaced with a more desirable gas, such as nitrogen. Removing the air from the product 500 may create a product 500 that better retains its shape when moved or deformed, but that has different thermal or insulating characteristics that a product 500 that is not vacuum-sealed. In some applications, a vacuum-sealed product 500 may be more desirable; however, in other applications it may be desirable to leave some or all of the air, or other gas, within the envelope 502 of the product 500. The beads 500 may be compressed corn-starch pellets. The beads may also be made of another material, but corn-starch is preferred for compostability and biodegradability as the pellets will completely dissolve in a natural solvent such as water.

With reference now to FIG. 7, a top perspective view of a shipping assembly 700 comprising a container 702 with an embodiment of the compostable and thermally-insulating packing product 100 positioned within the interior 704 container is provided. To form a shipping assembly, the product 100 is positioned with the middle section 110 towards the bottom 706 of the interior 704 of the container 702. The arms 120, 122, 130, and 132 are folded upwards relative to the middle section 110 towards the top 708 of the container 702. The shorter arms 120 and 122 will be positioned at the top 708 of the container and, when in the folded configuration, will not extend beyond the top 708. The arms 130 and 132 are relatively longer than the shorter arms 120 and 122 and will extend beyond the top 708 of the container 702. The length of the arms 130 and 132 that extends beyond the top 708 of the container 702 may be folded over inwards towards each other to form a top layer opposite the middle section 110 and forming a fully enclosed space enclosed by the product 100 within the container 702. This fully enclosed space formed by the folded configuration of the product 100 is used to thermally and physically insulate a product or item being shipped in the shipping assembly 700.

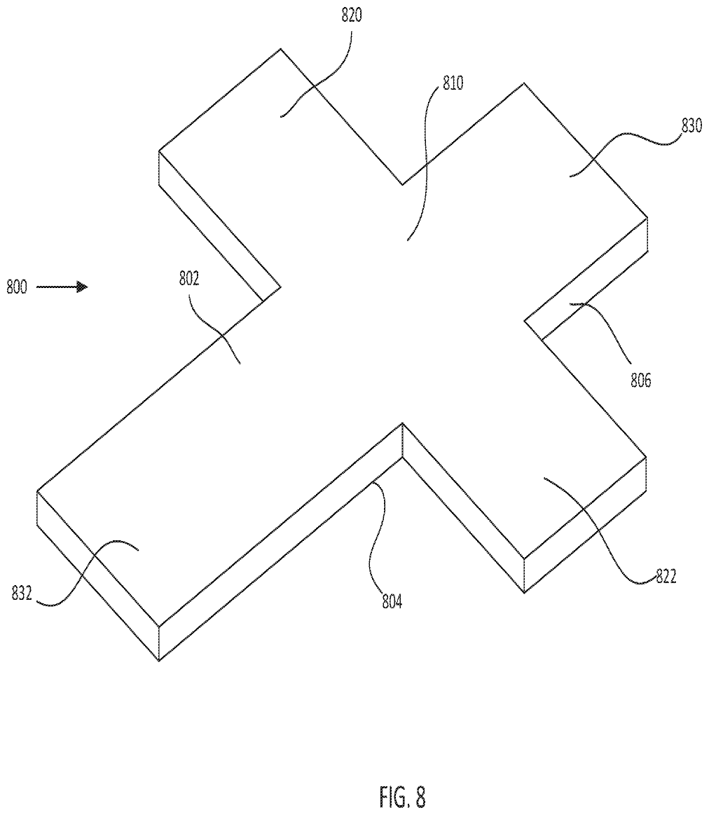

With reference now to FIG. 8, a top perspective view an embodiment of a compostable and thermally-insulating packing product 800 having three arms 820, 822 and 830 of equal length and having one arm 832 of a longer length unequal to that of the other arms according to the present invention is provided. The packing product 800 is generally cross-shaped and has four arms 820, 822, 830, and 832 disposed on perpendicular axes and in the same plane as a middle section 810. A top thin-film layer 802 and bottom thin-film layer 804 may be joined to a side layer 806 forming an envelope within which a plurality of compressed compostable beads may be contained. The top 802 and bottom 804 thin film layers may also be joined directly together as shown in FIGS. 3 and 4 or may be a single layer joined at the ends of each arm 820, 822, 830, and 832 as shown in FIG. 5. The entire exterior of the product 800 is comprised of a compostable and/or biodegradable thin-film material. One arm, arm 832, may be longer than the other three arms, arm 820, 822 and arm 830, to provide for completely enclosing an item within a shipping container, as shown in FIG. 7. The thickness of the side 806 of the product 800 is approximately 2 inches. The length of arm 832 is approximately 42-54 inches, and the length of the arms 820, 822 and 830 is approximately 25 inches. However, the lengths of each arm may be changed to fit the shipping container in which the product 800 is to be used. A portion of the arm 832 forms the top of an enclosure when folded over within a container similar to the product 100 as shown in FIG. 7.

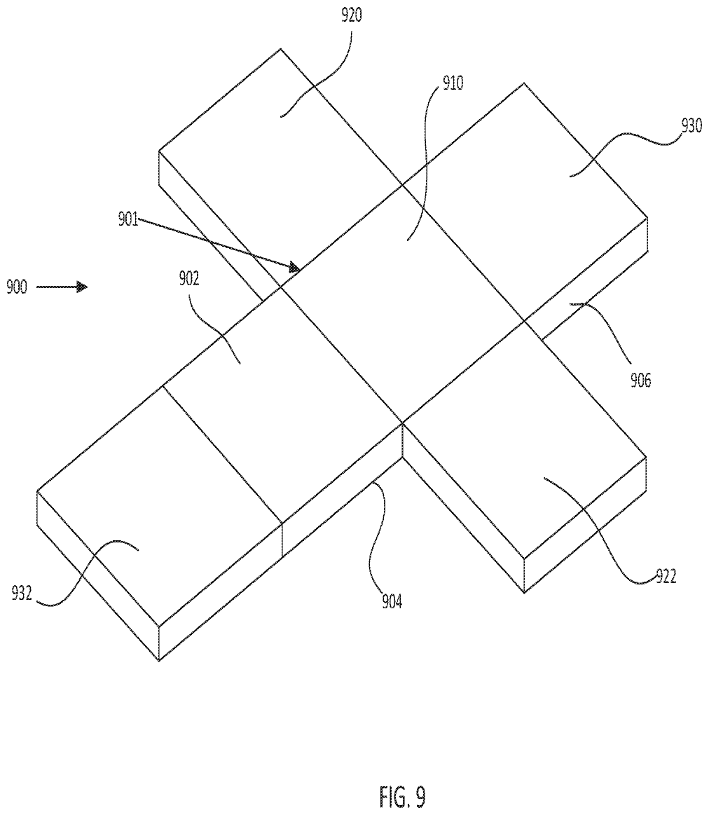

With reference now to FIG. 9, a top perspective view an embodiment of a compostable and thermally-insulating packing product 900 having three arms 920, 922 and 930 of equal length and having one arm 932 of a longer length unequal to that of the other arms and comprising a set of creases or folds 901 according to the present invention is provided. The packing product 900 is generally cross-shaped and has four arms 920, 922, 930, and 932 disposed on perpendicular axes and in the same plane as a middle section 910. A top thin-film layer 902 and bottom thin-film layer 904 may be joined to a side layer 906 forming an envelope within which a plurality of compressed compostable beads may be contained. The top 902 and bottom 904 thin film layers may also be joined directly together as shown in FIGS. 3 and 4 or may be a single layer joined at the ends of each arm 920, 922, 930, and 932 as shown in FIG. 5. The entire exterior of the product 900 is comprised of a compostable and/or biodegradable thin-film material. One arm, arm 932, may be longer than the other three arms, arm 920, 922 and arm 930, to provide for completely enclosing an item within a shipping container, as shown in FIG. 7. The set of folds 901 may permit each of the arms 920, 922, 930, and 932 to more easily fold together to form an enclosure within the shipping container.

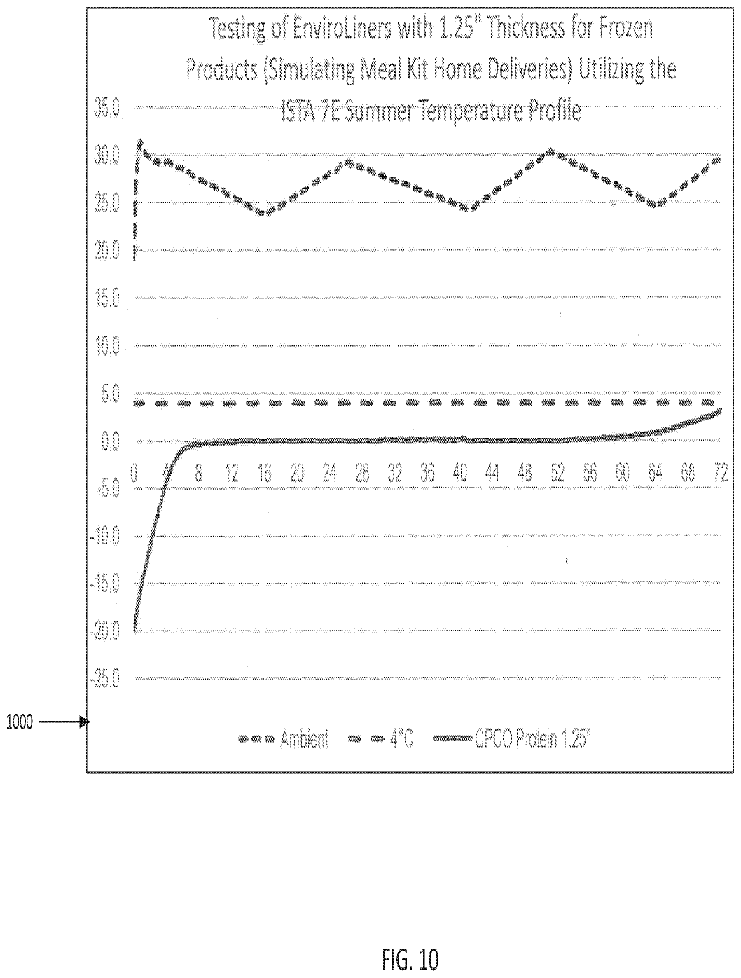

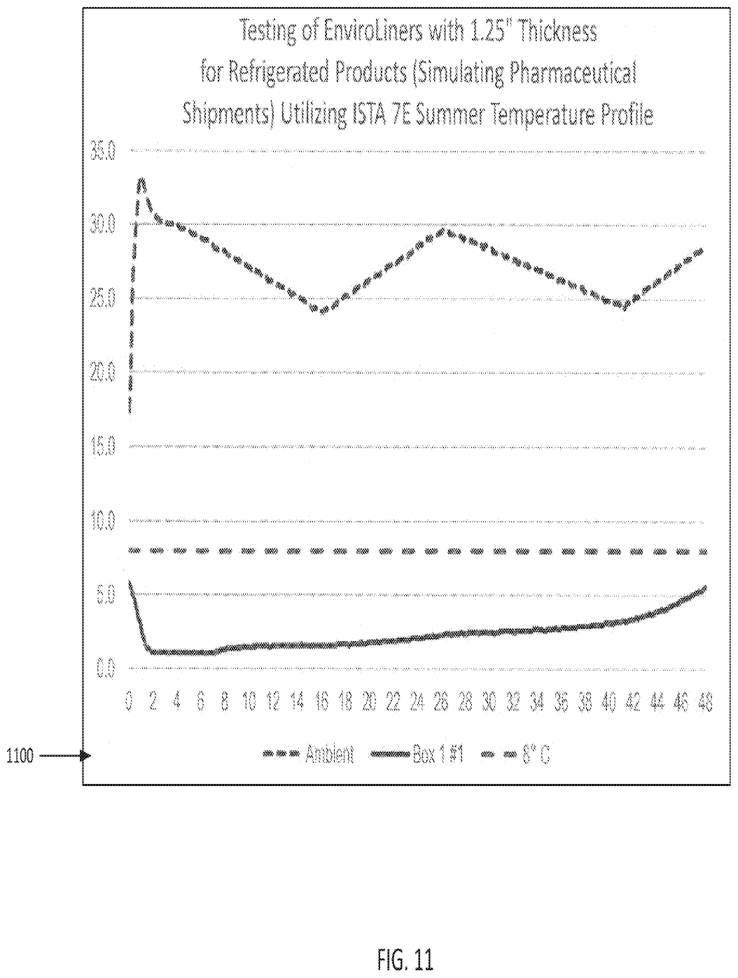

Additionally, one or more of the folds 901 may permit portions of the packaging product 900, such as the middle section 910 and the arm 932, to form respective bottom and top of an enclosure within a shipping container. This enclosure protects and thermally insulates an item or product in the enclosure within the shipping container and maintains a relatively stable internal temperature. The packaging product 900 is filled with a pelletized filler material and may be fully or partially vacuum sealed to form an insulating, protective layer between the item in the enclosure and the shipping container. This enclosure protects the item or product being shipped from physical shocks and from changes in temperature. For example, the packaging product 900 may maintain an internal temperature of below 4 degrees Celsius for a period of 72 hours while the exterior of a shipping container is subjected to changing temperatures reaching over 30 degrees Celsius and averaging over 25 degrees Celsius. As shown in the chart 1000 in FIG. 10 and in the chart 1100 in FIG. 11, the internal temperature of the enclosure or product in the enclosure is maintained below a target temperature, 8 degrees Celsius for 48 hours in chart 1000 and 4 degrees Celsius for 72 hours in chart 1100, when exposed to relatively high and changing external or ambient temperatures.

With reference again to FIG. 9, the thickness of the side 906 of the product 900 is approximately 2 inches. The length of arm 932 is approximately 42-54 inches, and the length of the arms 920, 922 and 930 is approximately 25 inches. However, the lengths of each arm may be changed to fit the shipping container in which the product 900 is to be used. A portion of the arm 932 forms the top of an enclosure when folded over within a container similar to the product 100 as shown in FIG. 7.

In another embodiment, the present invention provides an insulating, compo stable packing product comprising: a body comprising a thin-film material and having a middle section, a first arm, a second arm, a third arm, and a fourth arm, the body further comprising an interior space, sides, and a thickness; wherein each of the first, second, third, and fourth arms are disposed cardinally about and extending outwards in a common plane from the middle section; a pelletized filler material disposed within the body of the packing product; and wherein the packing product is adapted to be folded within a container to form an enclosed space within the container for thermally insulating and physically isolating an item within the enclosed space in the container.

The packaging product of the above embodiment may further comprise wherein the thin-film material comprises a compostable thin-film material. The thin-film material may comprise a water-soluble thin-film material. The pelletized filler material may comprise a water-soluble material. The pelletized filler material may comprise a plurality of compostable, insulating corn-starch based pellets. The first arm may be relatively longer than the second, third, and fourth arms. The first arm and the second arm may be relatively longer than the third arm and the fourth arm. The body may comprise a top layer and a bottom layer joined at a seam about the sides of the body. The body may comprise a single sheet of thin-film material sealed at the ends of each of the first, second, third, and fourth arms. The thickness of the body may be 2 inches. The thickness of the body may be 1.25 inches. The packaging product may further comprise wherein a portion of the first arm is adapted to form a top of the enclosed space within the container when the body of the product is folded within the container. The packaging product may maintain a temperature below 4 degrees Celsius within the enclosed space for a period of 72 hours when exposed to an external temperature exceeding 25 degrees Celsius. The packaging product may maintain a temperature below 8 degrees Celsius within the enclosed space for a period of 48 hours when exposed to an external temperature exceeding 25 degrees Celsius.

In another embodiment, the present invention provides an insulating, compo stable packing product adapted to be folded within a container to form an enclosed space within the container for thermally insulating and physically isolating an item within the enclosed space in the container, the packing product comprising: a body comprising a compostable thin-film material, a middle section, a first arm, a second arm, a third arm, a fourth arm, an interior space, a set of sides, and a thickness; wherein the interior space formed by and is disposed within the compostable thin-film material and is sealed by a partial vacuum; wherein each of the first, second, third, and fourth arms are disposed cardinally about and extending outwards in a common plane from the middle section, and the first arm is relatively longer than the second, third, and fourth arms; and a water-soluble, pelletized filler material disposed within the body of the packing product, the water-soluble, pelletized filler material forming a thermally insulating and physically isolating layer and having a malleable, semi-rigid structure; wherein the packaging product maintains a temperature below 8 degrees Celsius within the enclosed space for a period of 48 hours when exposed to an external temperature exceeding 25 degrees Celsius.

The packaging product of the above embodiment may further comprise wherein the body comprises a top layer and a bottom layer joined at a seam about the sides of the body. The body may comprise a single sheet of thin-film material sealed at the ends of each of the first, second, third, and fourth arms. The thickness of the body may be between 1.25 and 2 inches, inclusive. The packaging product may further comprise wherein a portion of the first arm is adapted to form a top of the enclosed space within the container when the body of the product is folded within the container. The packaging product may maintain a temperature below 4 degrees Celsius within the enclosed space for a period of 72 hours when exposed to an external temperature exceeding 25 degrees Celsius.

In another embodiment the present invention provides an insulated shipping assembly for providing an enclosed space for thermally insulating contents from ambient temperature, the shipping assembly comprising: a container having four sides, a top and a bottom defining a first interior space; and a compostable and thermally-insulating packing product comprising: a body defined by a skin of thin-film material, the body having an unfolded configuration and a folded configuration, when unfolded the body being essentially cross-shaped and having an essentially square-shaped central portion with four arm portions extending outward from respective sides of the square-shaped central portion, each of the four arm portions adapted to be folded upward at a respective side of the square-shaped central portion; a pelletized filler material disposed within the body skin, the body skin being sealed to prevent release of the filler material; wherein the compostable and thermally-insulating packing product is adapted to be folded and positioned within the first interior space of the container so as to define a second interior space within the first interior space to receive for shipping a set of thermally-sensitive contents; and wherein the filler material has thermal insulative qualities for thermally insulating and isolating the set of thermally-sensitive contents when enclosed within the first and second interior spaces.

The insulated shipping assembly of the above embodiment may further comprise wherein at least one of the four arm portions includes a top portion adapted to fold over and enclose the second interior space within the first interior space. The four arm portions may be folded upwards relative to the central portion, with the body disposed within the first internal space and with the central portion disposed over the bottom of the container and the four arms adjacent respective ones of the container four sides. The insulated shipping assembly may further comprise wherein two of the four arm portions are relatively shorter than the other two arm portions and with the body disposed within the first interior space the distal ends of the shorter arms extend to the top of the container and, the relatively longer arm portions extending beyond the top of the container, whereby the length of the two relatively longer arms that extend beyond the top of the container are configured to be folded over inwards towards each other to form a top layer opposite the central portion and enclosing the second interior space within the container.

Referring again to FIG. 9, the depicted thermally-insulating packing product 900 having three arms 920, 922 and 930 of equal length and having one arm 932 of a longer length unequal to that of the other arms and comprising a set of creases or folds 901 according to the present invention may be constructed of a single sheet of polyethylene terephthalate fiber material (commonly known as PET fiber) having a predetermined thickness according to the desired insulation properties of the packaging product. In certain embodiments the single sheet of PET fiber material is folded to produce a liner for a packing box. The liner may be folded to fit closely inside a packing box, thereby insulating the contents thereof. Packaging product 900 is generally cross-shaped and has four arms 920, 922, 930, and 932 disposed on perpendicular axes and in the same plane as a middle section 910. In these embodiment one arm, arm 932, may be longer than the other three arms, arm 920, 922 and arm 930, to provide for completely enclosing an item within a shipping container, as shown in FIG. 7. The set of folds 901 may permit each of the arms 920, 922, 930, and 932 to more easily fold together to form an enclosure within the shipping container.

In accordance with some embodiments the PET fiber material that forms packaging product 900 may be singed or heated along all exterior surfaces thereof to produce a packaging product having exterior surfaces 901 that are sealed and thus are relatively impervious to fluids as well as having additional insulating value for a packaging product. The packaging product of these embodiments may be produced by heating a shaped PET fiber body, whether in one piece or multi-piece construction, under pressure in a press or equivalent apparatus. In some embodiments, once heated packaging product 900 has an exterior heated or “singed” layer having a predetermined thickness to protect the products contained within and to insulate. In some embodiments the “singed” layer may be between 1/16″ to ⅛″ in thickness.

In accordance with some embodiments PET fiber material packaging product 900 exterior surface 901 are subjected to heat in a press at between 275 and 375 degrees F. In some embodiments the PET fiber material is under 0.75 PSI of pressure while being heat treated or singed. In yet further aspects the PET fiber material is heated and pressurized for 3 seconds at 350 degrees F. and 0.75 PSI to produce a singed outer layer.

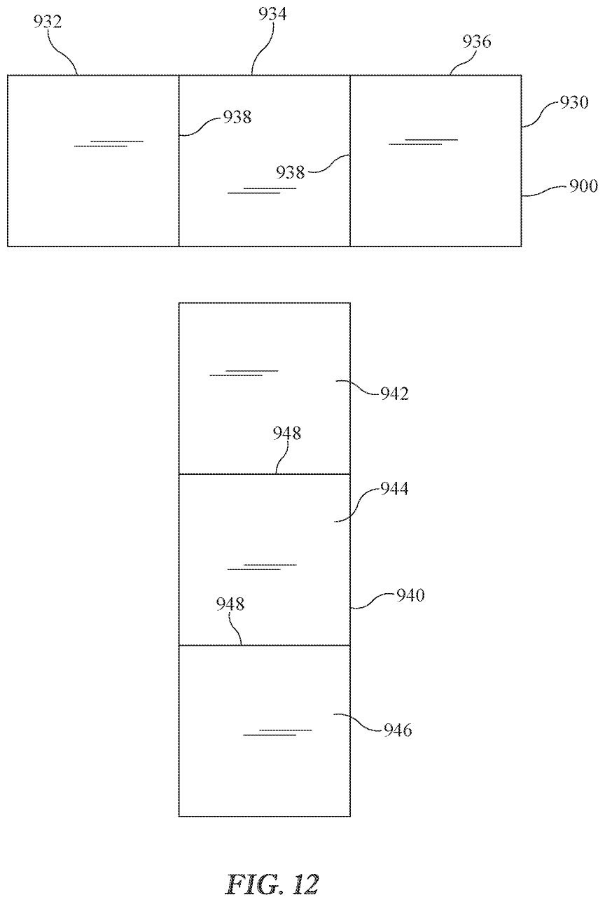

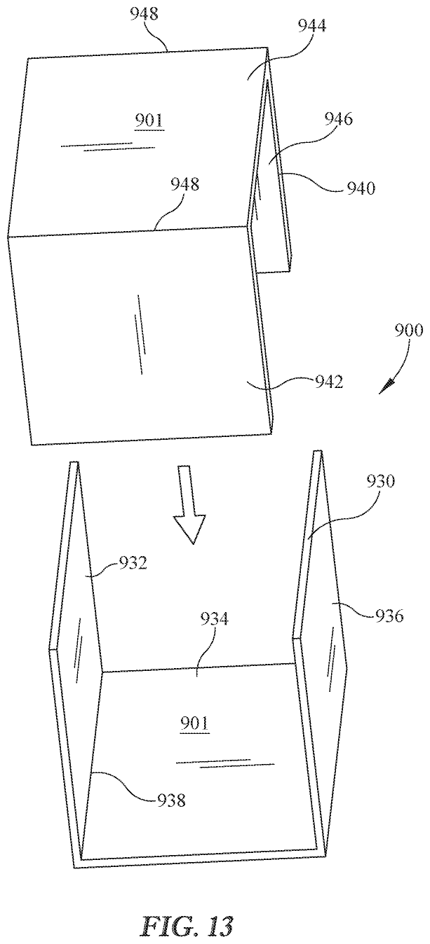

With reference now to FIGS. 12 and 13, in some embodiments two pieces 930, 940 of PET fiber material may be assembled to provide a packaging product. Each piece 930, 940 of PET fiber may be folded and then assembled in a nesting fashion to provide packaging product 900. In these exemplary but non-limiting embodiments a first PET fiber piece 930 may be generally rectangular and be sub-divided into three sections 932, 934 and 936, separated by a fold or scored line 938 to facilitate folding. Similarly, a second PET fiber piece 940 may also be generally rectangular and be sub-divided into three sections 942, 944 and 946, separated by a fold or scored line 948. As best depicted in FIG. 13 pieces 930 and 940 are folded along scores or folds 938, 948 and then nested together as shown to produce a packaging product 900 suitable for a box liner or the equivalent. Additionally, individual sections 932, 934, 936, 942, 944, 946 of each piece 930, 940 may be sized to produce a packaging product 900 of a predetermined size for a given box or package. In accordance with some aspects of the invention each exterior surface of pieces 930, 940 are heat treated as detailed herein above to produce a sealing layer on the exterior surfaces thereof.

In a further embodiment of the invention PET fiber material may be coated on top 902 and bottom 904 with a thin film corn starch layer that may also be joined directly together as shown in FIGS. 3 and 4 or may be a single layer joined at the ends of each arm 920, 922, 930, and 932 as shown in FIG. 5. The entire exterior of the product 900 is then comprised of a compostable and/or biodegradable thin-film corn starch material.

While the invention has been described by reference to certain preferred embodiments, it should be understood that numerous changes could be made within the spirit and scope of the inventive concept described. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1) An insulating packing product comprising:
a body comprising an insulating material and having a middle section, a first arm, a second arm, a third arm, and a fourth arm, the body further comprising an exterior sealing layer, an interior, sides, and a thickness;
wherein when unfolded each of the first, second, third, and fourth arms are disposed about and extending outwards in a common plane from the middle section; and
wherein the packing product is adapted to be folded within a container to form an enclosed space within the container for thermally insulating and physically isolating a set of items within the enclosed space in the container.

2) The packaging product of claim 1, wherein the material comprises PET fiber material.

3) The packaging product of claim 2, wherein the PET fiber material is heated to form said exterior sealing layer.

4) The packaging product of claim 3, wherein the body forms a six-sided volume for insulating a box.

5) The packaging product of claim 1, wherein the first arm is relatively longer than the second, third, and fourth arms.

6) The packaging product of claim 1, wherein the exterior sealing layer comprises pet fiber heated top layer, a pet fiber heated bottom layer and pet fiber heated sides.

7) The packaging product of claim 1, wherein the body comprises a single sheet of pet fiber material singed on all surfaces by heating at the exterior layer and at the ends of each of the first, second, third, and fourth arms.

8) The packaging product of claim 1, wherein a portion of the first arm is adapted to form a top of the enclosed space within the container when the body of the product is folded within the container.

9) The packaging product of claim 1, wherein the packaging product maintains a temperature below 4 degrees Celsius within the enclosed space for a period of 72 hours when exposed to an external temperature exceeding 25 degrees Celsius.

10) The packaging product of claim 1, wherein the packaging product maintains a temperature below 8 degrees Celsius within the enclosed space for a period of 48 hours when exposed to an external temperature exceeding 25 degrees Celsius.

11) An insulating packing product adapted to be folded within a container to form an enclosed space within the container for thermally insulating and physically isolating an item within the enclosed space in the container, the packing product comprising:
a body comprising a PET fiber material having an exterior surface, a middle section, a first arm, a second arm, a third arm, a fourth arm, an interior surface, a plurality of sides, and a thickness;
wherein each of the first, second, third, and fourth arms are disposed cardinally about and extending outwards in a common plane from the middle section, and the first arm is relatively longer than the second, third, and fourth arms; and
wherein said exterior layer, said interior layer, and said sides are heat treated to produce a hardened exterior layer, interior layer and sides.

12) The product of claim 11 wherein said exterior layer, said interior layer, and said sides are heat treated at a temperature range between 275 and 350 degrees F. to produce a hardened exterior layer, interior layer and sides.

13) The product of claim 11 wherein said exterior layer, said interior layer, and said sides are heat treated at a temperature range between 275 and 350 degrees F. for 3 seconds to produce a hardened exterior layer, interior layer and sides.

14) The product of claim 11 wherein said exterior layer, said interior layer, and said sides are heat treated at a temperature range between 275 and 350 degrees F. and subjected to 0.75 PSI pressure for 3 seconds to produce a hardened exterior layer, interior layer and sides.

15) The product of claim 11 wherein said exterior layer, said interior layer, and said sides are heat treated at a temperature of 350 degrees F. for 3 seconds to produce a hardened exterior layer, interior layer and sides.

16) The packaging product of claim 11, wherein the body comprises a top layer and a bottom layer joined at a seam about the sides of the body.

17) The packaging product of claim 11, wherein the body comprises a single piece of PET fiber material that is folded to produce a box.

18) The packaging product of claim 11, wherein the body comprises a single sheet of corn starch thin-film material sealed at the ends of each of the first, second, third, and fourth arms.

19) The packaging product of claim 11, the body comprises two pieces of PET fiber material that is folded to produce a box.

20) The packaging product of claim 11, wherein the packaging product maintains a temperature below 4 degrees Celsius within the enclosed space for a period of 72 hours when exposed to an external temperature exceeding 25 degrees Celsius.
